(19) United States
(12) Patent Application Publication
(10) Pub. No.: US 2005/0268231 A1
(43) Pub. Date: Dec. 1, 2005

(54) Method and device for inputting Chinese phrases

(75) Inventors: Yandong Wen, Beijing (CN); Meng Lu, Beijing (CN); Gekai Zou, Beijing (CN); Donglai Luo, Beijing (CN); Yanqing Cui, Shandong Province (CN); Zhe Nan, Tianjing (CN); Yong Gou, Beijing (CN); Wenjing Guo, Beijing (CN)

Correspondence Address: HARRINGTON & SMITH, LLP, 4 RESEARCH DRIVE, SHELTON, CT, 06484-6212, US

(73) Assignee: Nokia Corporation

(21) Appl. No.: 11/140,434

(22) Filed: May 27, 2005

(30) Foreign Application Priority Data
May 31, 2004 (CN) 200410046213.4

(51) Int. Cl. G06F 17/21

(52) U.S. Cl. 715/534; 715/535

(57) ABSTRACT

The present invention discloses A method for inputting a Chinese phrase on a portable device, said device comprising a keyboard, a display means and a memory means, said method comprising the steps of: inputting Chinese Pinyin letter/Zhuyin character and other characters by the keyboard; entering a Chinese phrase matched mode when detecting that a first separator for separating Chinese Pinyin letter/Zhuyin character corresponding to different Chinese characters is input; under the Chinese phrase matched mode, searching in the memory means the Chinese phrase corresponding to the input Chinese Pinyin letter/Zhuyin character and the number and the position of the separator based on the input Chinese Pinyin letter/Zhuyin character and the number and the position of the separator; and, sending the searched Chinese phrase to the display means.

### FIELD OF THE INVENTION

The present invention relates to a method and a device for inputting letters, and more specifically, to a method and a device for inputting a Chinese phrase.

### BACKGROUND OF THE INVENTION

The key on a keyboard for inputting a Chinese character in most popular equipments is identified by an English letter. One example of this kind of keyboard is the English QWERTY keyboard. One method for inputting Chinese character is accomplished through the corresponding relation between Chinese character and Chinese Pinyin letter/Zhuyin character based on the fact that the number of Chinese Pinyin letters/Zhuyin characters is far less than the number of Chinese characters. Zhuyin is the spell for labeling Chinese characters used in Taiwan, which includes initial consonant, vowel ending, compound vowel ending and tone marks. Each Chinese Pinyin letter/Zhuyin character may correspond to only one English letter, while each English letter may correspond to only one Chinese Pinyin letter/Zhuyin character, that is, it can be set up one by one corresponding relation between Chinese Pinyin letters/Zhuyin characters and English letters.

In such a method for inputting Chinese characters, the above one by one corresponding relation between English letter and Chinese Pinyin letter/Zhuyin character is fist set up on keyboard. Thus, the corresponding Chinese Pinyin letter/Zhuyin character can be input through pressing the key corresponding to Chinese Pinyin letter/Zhuyin character on keyboard. Then, the input Chinese Pinyin letters/Zhuyin characters is converted into Chinese characters. Thus, the input of Chinese characters is completed.

In fact, with the above method, many devices have realized single Chinese character input, even Chinese phrase input. Single Chinese character input means that only one Chinese character can be input through one inputting operation. Chinese phrase input means that one Chinese phrase can be input through one inputting operation. For example, if a user wants to input a Chinese character [symbol] first, he inputs Chinese Pinyin letters “zhong”, then presses selection key. Thus, he completes the inputting of the Chinese character. If a user wants to input Chinese phrase [symbol] first, he inputs Chinese Pinyin letters “zhongguo”, then presses selection key. Thus, he completes the inputting of the Chinese phrase. The meaning of “one inputting operation” here is a full procedure that includes the steps of: pressing a key identified by an English letter one or more times to input information, and pressing a predefined confirmation key one time to confirm the input information. The Chinese character inputting method experiences a development process from supporting single Chinese character input to Chinese phrase input, and such a development increases greatly the effectiveness of the Chinese character input.

As is well known, the ITU-T keyboard is widely used along with the increasing popularization of mobile telephone. ITU-T keyboard is a standard keyboard, which mainly includes number keys 0-9. These number keys can be used to input telephone number. Further, some number keys correspond to the 26 English letters and are used to input these letters. For example, number key 2 represents A, B and C; number key 3 represents D, E and F; number key 4 represents G, H and I; number key 5 represents J, K and L; number key 6 represents M, N and O; number key 7 represents P, Q, R and S; number key 8 represents T, U and V and number 9 represents W, X, Y and Z.

Hence, it is not convenient to only using these keys to input Chinese Pinyin letter into mobile telephone. Since the number of the key is limited, each key corresponds to several English letters. Thus, it needs pressing a key one or more times in order to input a predefined English letter. For example, a user is probably required to press number key 7 four times in order to input a single English letter “S”. It is not an easy job to correctly input two or three Chinese Pinyin letters or Zhuyin characters so as to input a correct single Chinese character. The same problem also exists when inputting an English word on a mobile phone.

At present, inputting of Pinyin letter/Zhuyin character on the ITU-T keyboard has been realized through single-tap inputting method. The meaning of single-tap inputting is that, for each English letter or Pinyin letter/Zhuyin character to be input, it only needs to press the key identified by the corresponding English letter one time, and obtains the corresponding English letter strings through pressing in turn the key corresponding to an English letter or Pinyin letter/Zhuyin character to be input, after fuzzily logic analyzing and judging the English letter strings or Pinyin letters/Zhuyin characters, displays the English letter strings which comply with the word-building rule or the Pinyin/Zhuyin rule, then, processes the English letter strings according to requirements, including outputting the English letter strings or searching the matched Chinese characters based on the English letter strings. For example, in order to input the Pinyin letters “zhong” corresponding to a Chinese character [symbol] it only needs to press the number keys 9, 4, 6, 6 and 4 one time.

Inputting of a single Chinese character and Chinese phrase has been realized using such single-tapping manner on ITU-T board. But, the method for inputting a Chinese phrase has the following problems: first, if a user doesn't know the Pinyin letter/Zhuyin character of each character in a Chinese phrase, then he cannot input the phrase; second, the user has to press a keyboard several times in order to input a Chinese phrase.

Hence, there is a need for a new method and a device for inputting a Chinese character in the art such that a user can input a Chinese phrase conveniently.

### SUMMARY OF THE INVENTION

Therefore, an embodiment of the present invention is a method for inputting a Chinese phrase on a portable device, the portable device including a keyboard, a display means and a memory means. The method includes: inputting at least a Chinese Pinyin letter or Zhuyin character; entering a Chinese phrase matched mode when detecting that a first separator for separating the Chinese Pinyin letter or Zhuyin character corresponding to different Chinese characters is input; under the Chinese phrase matched mode, searching in the memory means the Chinese phrase corresponding to the input Chinese Pinyin letter or Zhuyin character and the number and the position of at least the first separator; and sending the searched Chinese phrase to the display means.

Preferably, the method for inputting a Chinese phrase of the present invention, wherein after entering the Chinese phrase matched manner, a second separator is input after the first separator.

Preferably, the method for inputting a Chinese phrase of the present invention, further including the step of searching a Chinese phrase in the memory means, the number of Chinese characters in the Chinese phrase is larger than the sum of all separators used in the searching.

Preferably, under Chinese phrase matched mode, another separator is input after the first separator, and the Chinese Pinyin letter/Zhuyin character corresponding to the last Chinese character of the Chinese phrase is finally input.

Preferably, inputting the Chinese Pinyin letter or Zhuyin character is by a single-tap inputting manner.

Preferably, detecting that the first separator is input includes detecting an input other than number keys 1 through 9 of a keyboard.

Preferably, the Pinyin letter/Zhuyin character corresponding to each Chinese character of the Chinese phrase is one or more Pinyin letters/Zhuyin Characters selected from the Chinese character's complete Pinyin/Zhuyin according to the alphabetical order.

Preferably, the portable device has an ITU-T keyboard.

Another embodiment of the present invention is a portable device for inputting a Chinese phrase. The device includes input means for inputting a Chinese Pinyin letter or Zhuyin character; processing means for detecting the input from the input means, and for entering a Chinese phrase matched mode when detecting that a first separator for separating a Chinese Pinyin letter or Zhuyin character corresponding to different Chinese characters is input, and under the Chinese phrase matched mode, for searching in the memory means a Chinese phrase corresponding to the input Chinese Pinyin letter or Zhuyin character in combination with the position of at least the first separator, and for sending a matched Chinese phrase to a display means; a memory means for storing Chinese phrase and providing a matched Chinese phrase to the process means; and a display means for displaying the matched Chinese phrase sent from the process means.

Preferably, the portable device is one of a mobile telephone, a personal digital assistant, a hand-held computer, and a pager.

### BRIEF DESCRIPTION ON THE DRAWINGS

The accompanying drawings, which are incorporated in and constitute a part of the specification, illustrate embodiments of the invention and, together with the description, serve to explain the principles of the invention.

FIG. 1 shows a typical mobile telephone;

FIG. 2 is a flow diagram of a method for inputting a Chinese character according to an embodiment of the present invention;

FIG. 3 is constituted by FIG. 3A to 3F, and shows an example of inputting a Chinese phrase according to an embodiment of the present invention;

FIG. 4 is constituted by FIG. 4A and FIG. 4B, and shows another example of inputting a Chinese phrase according to an embodiment of the present invention;

FIG. 5 is a block diagram of a device for inputting a Chinese phrase according to an embodiment of the present invention.

### DETAILED DESCRIPTION

Embodiments of the present invention will be described in detail in accordance with the accompanying drawings, wherein the same reference numeral represents the same or similar components.

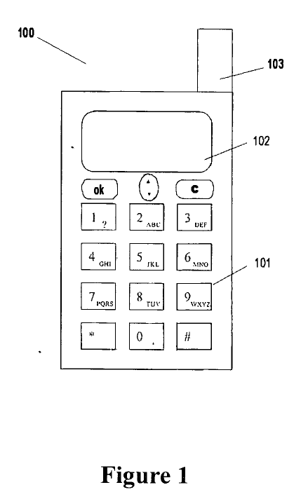

FIG. 1 shows a typical mobile telephone. The mobile telephone 100 includes a keyboard 101, a display 102, an antenna 103, and a memory (not shown) etc.

Like Pinyin letters, Chinese Zhuyin characters correspond to English letters on keys of a keyboard one by one. Thus, embodiments of the present invention are described in detail with only Chinese Pinyin taken for example. It should be appreciated that the present invention is also suitable to Chinese Zhuyin. The principle of the method for inputting Chinese phrase based on Chinese Zhuyin is the same as that based on Chinese Pinyin.

As shown in FIG. 1, keyboard 101 is achieved using a keyboard having 10 number keys—number keys 0-9—and other function keys such as answer key, cancel key and menu key. A display 102 is used, for displaying telephone number, short message, input text and the like.

English letters or Chinese Pinyin letters can be input through number keys 2-9, for example, English letters or Chinese Pinyin letter D, E and F can be input by using number key 3.

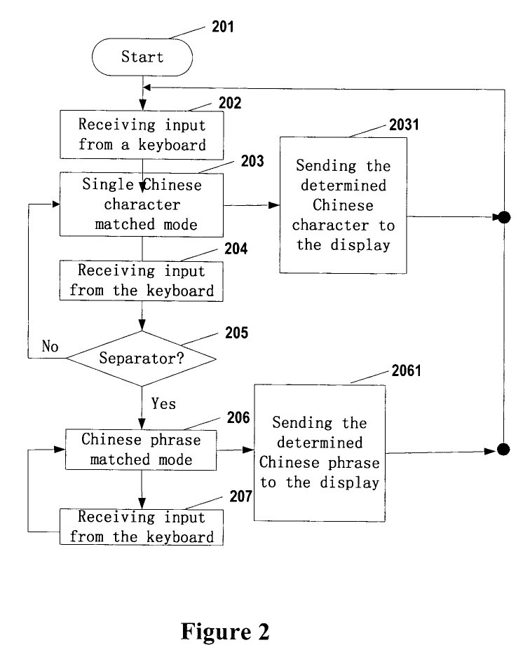

FIG. 2 shows a flow diagram of a method for inputting a Chinese character according to an embodiment of the present invention. The method is capable of conveniently inputting a Chinese phrase on a portable device, particularly, on a mobile telephone having ITU-T keyboard as shown in FIG. 1.

Hereinafter, the method for inputting a Chinese phrase according to an embodiment of the present invention will be described with reference to FIG. 2. First, the flow starts in step 201. In step 202, a user inputs Chinese Pinyin letter with a single-tap inputting manner using keys on keyboard 101.

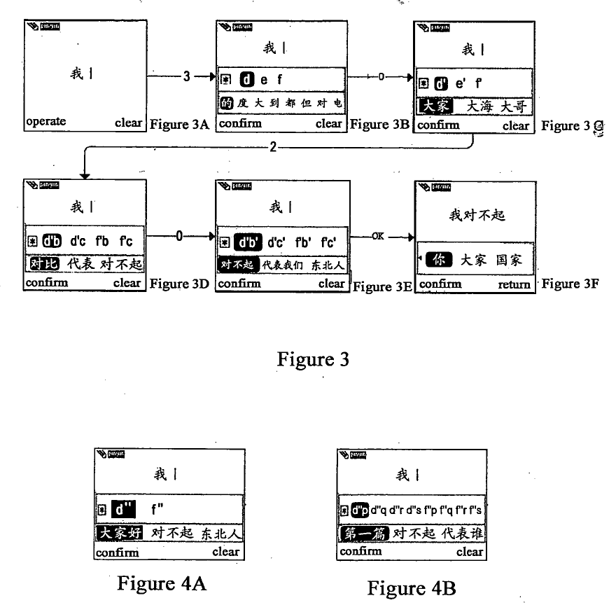

Hereinafter, an example of inputting Chinese phrase [symbol] will be described with reference to FIG. 3. Since the complete Pinyin letters corresponding to Chinese phrase [symbol] is “dui bu qi”, in step 202, the user first presses once number key 3 of keyboard 101 with single-tap inputting manner to input Chinese Pinyin letter “d”. Then the flow goes into step 203.

In this embodiment, after pressing a key corresponding to a Chinese Pinyin letter once, the mobile telephone 100 will analyze and judge the key combination with respect to the key pressed in the present inputting operation, i.e. the possible combination of the English letters, based on the Pinyin rules, and display the English letters in accordance with the Pinyin rules, namely the Chinese Pinyin letters in this embodiment, and display the Chinese character corresponding to the Chinese Pinyin letters on a display.

If there are several Chinese Pinyin in conform to the Pinyin rules, the mobile telephone 100 will highlight one Chinese Pinyin letters on the display, at the same time, display the Chinese character corresponding to the highlighted Chinese Pinyin letters on the display. Under such a condition, the user can use the asterisk key (*) shown in FIG. 1 to select a desirable Chinese Pinyin letters from the displayed several Chinese Pinyin letters according to requirements. The selected Chinese Pinyin letters will be highlighted on the display. Here, the asterisk key (*) is a predefined selection key used for selecting desirable Chinese Pinyin letters, and is named as a first selection key. With such a selection made by the user, the Chinese characters displayed in the display and corresponded to the highlighted Chinese Pinyin are changed accordingly. Then, the user can select the desirable Chinese character using direction key (⇄) on keyboard as shown in FIG. 1. Here, the direction key (⇄) is a predefined selection key used for selecting a desirable Chinese character, and is named as a second selection key.

The first selection key and the second selection key are generally called selection key, and can be any other keys on keyboard 101 except number keys 2-9, keys used for confirming the input and keys corresponding to separators. Keys used for confirming the input, for example, can be the OK key on keyboard 101. Pressing of such a key means the termination of a complete input operation. The confirmation key can be any other key on keyboard 101 except number keys 2-9, selection keys and keys corresponding to separators. It should be appreciated that the asterisk key (*), direction key (⇄) and OK key do not constitute limitation on the present invention.

In step 203, the mobile telephone 100 goes into single Chinese character matched mode, and displays the matched single Chinese character on the display. The flow goes into step 2031 when a target single Chinese character is found after moving the selection key. In step 2031, the single Chinese character confirmed by the user is sent to the Chinese character edit area on the display 102, thereby completing the inputting of a single Chinese character.

Every time the inputting of a single Chinese character is completed, the mobile telephone 100 will automatically display other single Chinese characters or Chinese phrases associational with the Chinese phrase in the display so as to facilitate the user to perform further inputting. When inputting a Chinese character, the user can either initiate or terminate such an association function. After step 2031, the flow returns back to step 202 for next input through keys on keyboard 101.

When no target single Chinese character is found after moving selection key, the flow goes into step 204. In step 204, the user continues inputting step by pressing a key in the keyboard. Then, the flow goes into step 205.

In step 205, the key information input by the user in step 204 is judged. If in step 205, it is detected that the key pressed by the user in step 204 is one identified by a English letter on keyboard 101, the flow returns back to step 203, and the mobile telephone 100 remains in the single Chinese character matched mode to perform user inputting by using single-tap inputting manner. If in step 205, it is detected that the key pressed by the user in step 204 is a predefined separator key on keyboard 101, then the flow goes into step 206.

As described above, number key 3 corresponds to Chinese Pinyin letters d, e and f. Hence, after pressing the above-mentioned number key, the Chinese Pinyin letter according with the Chinese Pinyin rules can be d, e and f as shown in FIG. 3B. Based on the input Chinese Pinyin d, e and f, the Chinese character corresponding to the input Chinese Pinyin letters d, e and f which are stored in a memory of the mobile telephone 100 are searched, and the searched corresponding Chinese characters are sent to the display 102, as shown in FIG. 3B, the Chinese characters displayed in the display 102 are [symbol] [symbol] [symbol] [symbol] [symbol] [symbol] [symbol] and

[symbol]

After inputting Pinyin letter “d”, the user presses the predefined separator key 0. In the present embodiment, the separator is displayed as “′”.

The separator is a symbol used for separating the Pinyin letters of different Chinese character in a Chinese phrase. The introduction of a separator serves the purpose of enabling the mobile telephone 100 to effectively divide a long Pinyin string into Pinyin letters corresponding to several single Chinese characters, thus facilitating further searching with respect to Pinyin string. Therefore, the introduction of separator greatly decreases the difficulty in processing Pinyin string for the mobile telephone and increases efficiency of processing. The present invention expands the function of separator and greatly enhances capability of searching.

The separator key is predefined and can be any other key on keyboard 101 except number keys 2-9, confirmation keys used to confirm user input and selection keys. In the present embodiment, the number key 0 is defined as the separator key. When the number key 0 is pressed, the single quotation mark “′” is displayed as a separator on the display. It should be appreciated that number key 0 and single quotation marks “′” constitute examples other than limitation on the present invention. The separator displayed on the display can be any other symbols except Pinyin letters, for example, blank, or even can be no symbols displayed.

In this embodiment, after judging in step 205 that the user presses a separator key 0, the flow goes into step 206. In step 206, the mobile telephone 100 goes into Chinese phrase matched mode, searches the Chinese phrase matched with input Chinese Pinyin letters in the memory means. When finding the matched Chinese phrase, it is displayed on the display means. When finding no matched Chinese phrase, blank information is displayed on the display means.

Then, the flow goes into step 207. In step 207, the user performs inputting through keyboard 101 of the mobile phone 100. Then, the flow goes into step 206 again.

In this embodiment, after pressing the separator key 0, results displayed on the display are that the Chinese phrases who have a larger number of characters than separators are displayed, for example, [symbol] [symbol] and [symbol] as shown in FIG. 3C. Then number key 2 is pressed. Since number key 2 corresponds to English letters or Chinese Pinyin letters a, b and c, the Chinese Pinyin strings corresponding to the inputting operation in the aforesaid steps are d′b, d′c, f′b and f′c. The Chinese phrases matched with Chinese Pinyin strings are searched in the memory means according to the Chinese Pinyin strings, and results of the search are displayed on the display. For example, as shown in FIG. 3D, the displayed Chinese phrases are [symbol] [symbol] and

[symbol]

Among a Chinese Pinyin string input with a method of the present invention, each Chinese Pinyin separated by the separator and corresponding to each Chinese character can be one or more Pinyin letters selected from the complete Pinyin letters of the Chinese character in alphabetic order, such as a single initial consonant or part of initial consonant, a single vowel ending or part of vowel ending, and combination of initial consonant or part of initial consonant with vowel ending or part of vowel ending. For example, for Chinese phrase [symbol] its input Pinyin letters can be any one form of “zh′g”, “z′g”, “ong′uo”, “ong′o”, “ong′g” and “zho′gu”. Whichever form of Chinese Pinyin letters the Chinese character corresponds to, the mobile telephone 100 can identify the Chinese Pinyin string separated by separator as two Chinese Pinyin corresponding to two Chinese characters, and search out the corresponding Chinese phrase

[symbol]

As shown in FIG. 3D, the displayed Chinese phrases are [symbol] [symbol] and [symbol] respectively. At this time, Chinese phrase [symbol] is highlighted. If [symbol] is to be input, the predefined confirmation key such as Ok key can be pressed directly, thereby completing the input of Chinese phrase

[symbol]

In addition, if Chinese phrase [symbol] to be input, since Chinese phrase [symbol] is first highlighted in FIG. 3D, the selection key is first pressed for selecting Chinese phrase [symbol] and highlighting it, then the predefined confirmation key such as Ok key is pressed, thus completing the input of Chinese phrase

[symbol]

In this embodiment, as shown in FIG. 3D, if the user does not press the selection key to select the Chinese phrase [symbol] or the Chinese phrase [symbol] is not displayed, the user can again press number key 0 to input separator, i.e., input Chinese Pinyin strings d′b′, d′c′, f′b′ and f′c′. Then, according to the Chinese Pinyin strings, the Chinese phrase corresponding to the Chinese Pinyin strings is searched in the memory and the results of the search are displayed on the display. Since two separators have been input, only Chinese phrase that is composed of more than two characters is searched.

For example, as shown in FIG. 3E, the displayed Chinese phrases are [symbol] [symbol] and [symbol] respectively. Since the Chinese phrase [symbol] corresponding Pinyin string d′b′ has already been highlighted, the predefined confirmation key such as OK key can be pressed directly, thus completing the input of Chinese phrase

[symbol]

Then, the flow goes into step 2061. In step 2061, the Chinese phrase [symbol] confirmed by the user is sent to the Chinese character edit area on the display 102, thereby completing the input of the Chinese phrase, as shown in FIG. 3F.

Every time the input of a Chinese phrase is completed, the mobile telephone 100 will automatically display the associational Chinese phrases or single Chinese character of the Chinese phrase at the lower part of the display so as to facilitate further input by the user. When performing the input of Chinese characters, the user can either initiate or terminate such association function. After step 2061, the flow returns back to step 202 for next input through keys on keyboard 101.

If a user is unable to input the Pinyin letters corresponding to a Chinese character of a Chinese phrase for some reason such as pronunciation, he can input a separator to search the desirable phrase.

Hereinafter, the above situation will be exemplified with reference to FIGS. 4A and 4B.

In this embodiment, the user wants to input Chinese phrase [symbol] whose Chinese Pinyin letters are “dui bu qi”, but he doesn't know or assure the Chinese Pinyin letter for Chinese character [symbol] First, he can press number key 3 one time to input Chinese Pinyin letter “d”, and press separator key 0 two times in a row, i.e., input two separators in succession As shown in FIG. 4A, results displayed on the display are Chinese phrases [symbol] [symbol] [symbol] etc, the number of whose Chinese characters is larger than the number of separators.

In order to quickly input the desirable Chinese phrase, the user finally presses number key 7 once to input Chinese Pinyin “q”. Since number key 3 corresponds English letter or Chinese Pinyin letters d, e and f, number key 7 corresponds to English letters or Chinese Pinyin letters p and q, the Chinese Pinyin strings corresponding to the inputting operation in the above step are d″p, d″q, d″r, d″s, f″p, f″q, f″r and f″s, as shown in FIG. 4B. Then, the Chinese phrase, whose first character is matched with Chinese Pinyin letter d or f and third character is matched with Chinese Pinyin letter p, q, r or s, is searched in the memory means, and results of the search are displayed on the display.

As shown in FIG. 4B, in the present embodiment, the displayed Chinese phrases are [symbol] [symbol] and [symbol] respectively. Since the target Chinese phrase [symbol] to be input has already been displayed on the display, the user can use the direction key, namely the second selection key, to select the corresponding Chinese phrase, and press the predefined confirmation key, for example, OK key, to complete the input of Chinese phrase

[symbol]

Similarly, it will be easy to input a longer Chinese phrase according to the above method of the present invention. For example, if a user wants to input Chinese phrase [symbol] since the first Chinese Pinyin letter of Chinese character [symbol] is “z”, the user can, in single-tap inputting manner, input the Chinese Pinyin letter “z” through pressing the number key 9 once, and input separator key 0 three times in a row. After that, the Chinese phrase [symbol] corresponding to Chinese Pinyin string “z′″” is displayed on the display. Finally, the user can press selection key and confirmation key to complete the input of Chinese phrase

[symbol]

It should be appreciated that different selection of separator key, selection key and confirmation key does not constitute limitation to the present invention. Any other keys except number keys 2-9 on the keyboard may be selected as the separator key, selection key and confirmation key.

The function of inputting Chinese phrases on a mobile telephone having ITU-T keyboard can be realized with the method according to present invention.

The present invention is described above with a mobile telephone taken for instance, but such is not a limitation to the present invention. A method for inputting a Chinese phrase according to the present invention can be realized using other portable devices such as portable personal digital assistant (PDA), hand computer, and pager.

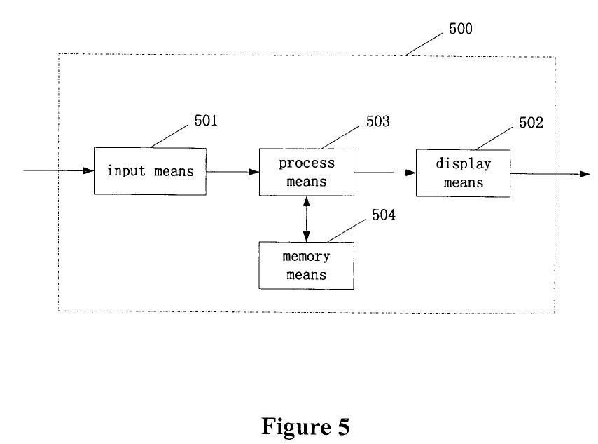

FIG. 5 is a block diagram of a device for inputting a Chinese phrase according to an embodiment of the present invention. A portable device 500 having the function of inputting Chinese phrases as shown in FIG. 5 comprises: a input means 501, a display means 502, a process means 503 and a memory means 504. Wherein, the input means 501 is used for inputting Chinese Pinyin letters/Zhuyin characters, separator and selection and confirmation command. The input means 501 sends the input in the above forms to the process means 503. Then, according to the input Chinese Pinyin letter/Zhuyin character and separator, the process means 503 searches the Chinese character corresponding to the Chinese Pinyin letter/Zhuyin character and separator through reading the memory means 504.

The portable device in accordance with the present invention can realize the Chinese Pinyin inputting of Chinese phrase. Thus, the efficiency of inputting Chinese of a portable device, particularly one having ITU-T keyboard, is greatly improved.

The above embodiments are described with reference to Chinese Pinyin. It should be appreciated that the present invention is also applicable to Chinese Zhuyin characters. Since the method for inputting a Chinese phrase with respect to Chinese Zhuyin is substantially the same as that with respect to Chinese Pinyin, details are omitted hereby. In the ensuing claims, a slash (/) between Pinyin letter and Zhuyin character indicates either a Pinyin letter or a Zhuyin character.

As many apparently widely different embodiments of the present invention can be made without departing from the spirit and scope thereof, it is to be understood that the invention and claims are not limited to the specific embodiments described in detail above.

1. A method for inputting a Chinese phrase on a portable device, the portable device comprising a keyboard, a display means and a memory means, the method comprising the steps of:
inputting at least a Chinese Pinyin letter/Zhuyin character;
entering a Chinese phrase matched mode when detecting that a first separator for separating Chinese Pinyin letter/Zhuyin character corresponding to different Chinese characters is input;
under the Chinese phrase matched mode, searching in the memory means a Chinese phrase corresponding to the input Chinese Pinyin letter/Zhuyin character and the position of at least the first separator; and,
sending the searched Chinese phrase to the display means.

2. A method for inputting a Chinese phrase as claimed in claim 1, wherein after entering the Chinese phrase matched manner, a second separator is input after the first separator, and the Chinese phrase corresponds to the input Chinese Pinyin letter/Zhuyin character and the positions of the first and second separators.

3. A method for inputting a Chinese phrase as claimed in claim 2 wherein a number of Chinese characters in the Chinese phrase is larger than the sum of all separators used in the searching.

4. A method for inputting a Chinese phrase as claimed in claim 1, wherein under the Chinese phrase matched mode, another separator is input after the first separator, and the Chinese Pinyin letter/Zhuyin character corresponding to a last Chinese character of the Chinese phrase is finally input.

5. A method for inputting a Chinese phrase as claimed in claim 4 wherein a number of Chinese characters in the Chinese phrase is larger than the sum of all separators used in the searching.

6. A method for inputting a Chinese phrase as claimed in claim 1, wherein inputting at least a Chinese Pinyin letter/Zhuyin character is by a single-tap inputting manner.

7. A method for inputting a Chinese phrase as claimed in claim 1, wherein detecting that the first separator is input comprises detecting input at a key of the portable device keyboard other than any of number keys 2 to 9.

8. A method for inputting a Chinese phrase as claimed in claim 1, wherein the Pinyin letter/Zhuyin character corresponding to each Chinese character of the Chinese phrase is one or more Pinyin letters/Zhuyin Characters selected from the Chinese character's complete Pinyin/Zhuyin according to alphabetical order.

9. A method for inputting a Chinese phrase as claimed in claim 1, wherein the portable device has an ITU-T keyboard.

10. A portable device for inputting a Chinese phrase, comprising:
input means for receiving user input of at least a Chinese Pinyin letter/Zhuyin character;
processing means for detecting the input from the input means, entering a Chinese phrase matched mode when detecting that a first separator for separating a Chinese Pinyin letter/Zhuyin character corresponding to different Chinese characters is input, and under the Chinese phrase matched mode, searching in the memory means a Chinese phrase corresponding to the input Chinese Pinyin letter/Zhuyin character and the position of at least the first separator, and sending a matched Chinese phrase to a display means;
memory means for storing Chinese phrases and providing a matched Chinese phrase to the processing means; and,
display means for displaying the matched Chinese phrase sent from the processing means.

11. A portable device for inputting a Chinese phrase as claimed in claim 10, wherein, for the case where after entering the Chinese phrase matched manner a second separator is detected, the processing means is for searching in the memory means a Chinese phrase corresponding to the input Chinese Pinyin letter/Zhuyin character and the positions of the first and second separators.

12. A portable device for inputting a Chinese phrase as claimed in claim 11, wherein a number of Chinese characters in the Chinese phrase is larger than the sum of all separators used in the searching by the processing means.

13. A portable device for inputting a Chinese phrase as claimed in claim 10, wherein under the Chinese phrase matched mode for the case where another separator and a Chinese Pinyin letter/Zhuyin character corresponding to a last Chinese character of the Chinese phrase is received at the input means after the first separator, the processing means is for searching in the memory means a Chinese phrase corresponding to the input Chinese Pinyin letter/Zhuyin character and the positions of the first and second separators and the last Chinese character of the Chinese phrase.

14. A portable device for inputting a Chinese phrase as claimed in claim 13, wherein a number of Chinese characters in the Chinese phrase is larger than the sum of the first separator and the other separators.

15. A portable device for inputting a Chinese phrase as claimed in claim 10, wherein the portable device receives a Chinese character or Chinese phrase at the input means by a single-tap inputting manner.

16. A portable device for inputting a Chinese phrase as claimed in claim 10, wherein the processing means detects the separator as an input to the input means other than number keys 2 to 9.

17. A portable device for inputting Chinese phrase as claimed in claim 10, wherein the input means comprises an ITU-T keyboard.

18. A portable device for inputting Chinese phrases as claimed in claim 10, wherein the portable device comprises one of a mobile telephone, a personal digital assistant, a hand-held computer and a pager.

19. A program of machine-readable instructions, tangibly embodied on an information bearing medium and executable by a digital data processor, to perform actions directed toward converting user inputs into a displayed Chinese phrase, the actions comprising:
mapping at least two user inputs such that one input corresponds to a Chinese Pinyin letter/Zhuyin character and another input corresponds to a separator;
using the at least two inputs, searching a database of Chinese phrases for all such phrases that match the mapped at least two inputs and their relative positions;
sending to a graphical display interface all of the matching Chinese phrases.

20. The program of claim 19, wherein the at least two user inputs comprise at least three user inputs, of which two correspond to separators in sequence with one another.

21. The program of claim 19, wherein the at least two user inputs comprise at least three user inputs, of which a first and third user input correspond respectively to a first and third Chinese Pinyin letter/Zhuyin character and a third user input corresponds to a separator disposed between the Chinese Pinyin letter/Zhuyin characters; and wherein searching the database comprises searching for all such phrases wherein a first and a last Chinese character of the Chinese phrase respectively matches the first and third Chinese Pinyin letters/Zhuyin characters.

22. The program of claim 19, wherein the at least two user inputs are received from an ITU-T keypad.

23. The program of claim 19, wherein the separator represents any Chinese character in a Chinese phrase.

24. The program of claim 19, wherein the information bearing medium and a digital data processor that executes the program are disposed within a portable hand-held electronic device.

25. The program of claim 24, wherein the device comprises a mobile station.

26. The program of claim 19, wherein the actions further comprise:
responsive to a user selecting at the graphical display interface one of the matching Chinese phrases, displaying the selected matching Chinese phrase and removing from the graphical display interface all of the matching Chinese phrases that are not selected.
